(19) United States
(12) Patent Application Publication
(10) Pub. No.: US 2024/0128489 A1
(43) Pub. Date: Apr. 18, 2024

(54) BATTERY, RFID TAG, AND MANUFACTURING METHOD

(71) Applicants: VARTA Microbattery GmbH, Ellwangen Jagst (DE); Elmeric GmbH, Rangendingen (DE); Bayer Aktiengesellschaft, Leverkusen (DE)

(72) Inventors: Sabrina LANG, Ammerbuch (DE); Martin KREBS, Rosenberg (DE); Werner FINK, Rangendingen (DE)

(21) Appl. No.: 18/278,015

(22) PCT Filed: Feb. 11, 2022
(86) PCT No.: PCT/EP2022/053395

§ 371 Date: Aug. 21, 2023

(30) Foreign Application Priority Data
Feb. 23, 2021 (EP) 21158807.4

(51) Int. Cl. H01M 10/04; G06K 19/07; H01M 4/42; H01M 50/46; H01M 50/51; H01M 50/528

(52) U.S. Cl. CPC H01M 10/0436; G06K 19/0723; H01M 4/42; H01M 50/46; H01M 50/51; H01M 50/528; H01M 2004/027

(57) ABSTRACT

A battery is provided for supplying a transmitter and/or receiver of a radio tag with an electrical current of. The battery includes a first and a second cell, each comprising a respective negative electrode, a respective positive electrode, and a respective separator. The battery further includes a plurality of separate electrical conductors, including a first conductor that electrically contacts a first electrode of the first cell, a second conductor that electrically connects a second electrode of the first cell to a first electrode of the second cell to form a series connection therebetween, and a third conductor that electrically contacts a second electrode of the second cell. The battery additionally includes a first substrate and a second substrate between which the first cell, the second cell, and the plurality of separate electrical conductors are arranged.

### CROSS REFERENCE TO RELATED APPLICATIONS

This application is a U.S. National Phase application under 35 U.S.C. § 371 of International Application No. PCT/EP2022/053395, filed on Feb. 11, 2022, and claims benefit to European Patent Application No. EP 21158807.4, filed on Feb. 23, 2021. The International Application was published in German on Sep. 1, 2022 as WO/2022/179865 under PCT Article 21(2).

### FIELD

The present disclosure relates to a battery and a radio tag which is supplied with electric current from the battery. Furthermore, the present disclosure relates to a method of manufacturing a battery.

### BACKGROUND

Radio tags can be used to track products of all kinds, for example pharmaceuticals and crop protection products. Such radio tags are described, for example, in WO 2019/145224 A1. They usually comprise a power supply unit, at least one sensor, a control unit, a data memory in which a unique product identifier is stored, and a transmitter and/or receiver unit. The sensor can be used to determine state information regarding the product, for example regarding the opening state of its packaging. The control unit can then cause the transmitting and/or receiver unit to transmit the status information and the product identifier to a data receiver. Ideally, the power supply unit should be able to supply the power required for this over a period of several months, with at least 50 incoming and outgoing data transmissions possible over this period.

The transmitter and/or receiver unit can basically be any data transmission device, for example, data transmissions according to the Wi-Fi standard (IEEE 802.11) and the Bluetooth standard (IEEE 802.15.1) are possible. However, to ensure worldwide tracking of products, it is appropriate to use cellular networks or other existing radio networks for data transmission.

Today, cellular networks cover large parts of the inhabited world, so they are particularly well suited for tracking products worldwide. However, mobile communications chips still have high requirements in terms of their energy consumption. This also applies to newer-generation mobile communications chips that transmit according to the LTE standard (LTE=Long Term Evolution). Depending on the selected radio protocol, peak currents of up to 400 mA must be available at least for short time windows.

For universal use, radio tags and thus also their power supply units must be as space-saving and inexpensive to manufacture as possible. In addition, environmental compatibility and safety are important parameters for all products in mass use. For these reasons, among others, printed batteries are considered as energy supply units in WO 2019/145224 A1.

However, the printed batteries known to date do not meet the requirements outlined above, or at best only partially. For example, the batteries described in US 2010/081049 A1 are not capable of delivering a peak current of the order of magnitude mentioned. Their impedance is too high.

### SUMMARY

In an embodiment, the present disclosure provides a battery for supplying a transmitter and/or receiver of a radio tag with an electrical current of in peak ≥400 mA. The battery includes a first cell and a second cell, each of the first cell and the second cell comprising a respective negative electrode, a respective positive electrode, and a respective separator disposed between the respective positive electrode and the respective negative electrode. The battery further includes a plurality of separate electrical conductors, which include a first conductor that electrically contacts a first electrode of the first cell, a second conductor that electrically connects a second electrode of the first cell to a first electrode of the second cell to form a series connection between the first cell and the second cell, the second electrode of the first cell and the first electrode of the second cell being of opposite polarity, and a third conductor that electrically contacts a second electrode of the second cell. The battery additionally includes a first substrate and a second substrate between which the first cell, the second cell, and the plurality of separate electrical conductors are arranged. The first and third conductors are disposed at a distance to each other on a surface of the first substrate facing the second substrate, and the second conductor is disposed on a surface of the second substrate facing the first substrate. The second electrode of the first cell and the first electrode of the second cell are arranged in a form of layers and side by side on the surface of the second substrate facing the first substrate, each covering a partial area of the second conductor and being separated from each other by a gap. The first electrode of the first cell and the second electrode of the second cell are arranged in a form of layers on the surface of the first substrate facing the second substrate, the first electrode of the first cell covering at least a partial region of the first conductor and the second electrode of the second cell covering at least a partial region of the third conductor. The respective separators of the first cell and the second cell, which are also in a form of layers, are each in surface contact with the second electrode of the first cell and/or the first electrode of the second cell with one of their sides and in surface contact with the first electrode of the first cell and/or the second electrode of the second cell with the other of their sides.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 provides an illustration of a preferred embodiment of a process for manufacturing a battery;

FIG. 2 illustrates a cross-section through the battery formed according to the process illustrated in FIG. 1;

FIG. 3 illustrates a cross-section through an alternative embodiment of a battery formed according to the process illustrated in FIG. 1;

FIG. 4 illustrates a radio tag with the battery shown in FIG. 2 (top view from above);

FIG. 5 illustrates two examples of a layer stack of a battery (top view vertically from above) with overlay areas of different sizes; and

FIG. 6 provides the result of a pulse test with a battery.

### DETAILED DESCRIPTION

The present disclosure was based on providing a power supply unit that is optimized in particular for supplying transmitter and/or receiver units of radio tags with electric current, in particular also for transmitter and/or receiver units that operate according to the LTE standard.

To solve this problem, the present disclosure provides a battery, a radio tag, and a method.

The term “battery” originally meant several electrochemical cells connected in series. This is also how it is used in the context of the present disclosure. The battery according to the disclosure comprises at least two electrochemical cells (single cells) which are electrically connected in series so that their voltages add up.

The battery according to the present disclosure preferably serves to supply a transmitter and/or receiver unit with an electrical current of ≥400 mA at peak. It can therefore supply electrical energy to mobile communication chips operating according to the LTE standard, among others. In principle, however, it is also suitable for other applications.

According to an aspect of the disclosure, a battery is provided that includes the immediately following features a. to g.:
a. It comprises a first and a second single cell formed as a layer stack, each having
   a negative electrode and
   a positive electrode and
   a separator placed between the positive electrode and the negative electrode,
b. it includes several separate electrical conductors, of which
   a first conductor electrically contacts one of the electrodes of the first single cell,
   a second conductor electrically connects the electrode of the first single cell, which is not contacted by the first conductor, to an oppositely poled electrode of the second single cell to establish a series connection, and
   a third conductor electrically contacts the electrode of the second single cell, which is not contacted by the second conductor, and
c. it comprises a first and a second substrate between which the single cells and the electrical conductors are arranged,
wherein
d. the first and third conductors are disposed in a distance to each other on a surface of the first substrate facing the second substrate, and the second conductor is disposed on a surface of the second substrate facing the first substrate,
e. the electrically connected electrodes of the first and second single cells are arranged in the form of layers and side by side on the surface of the second substrate facing the first substrate, each covering a partial area of the second conductor and being separated from each other by a gap,
f. the electrodes which are not connected to one another via the second conductor are arranged in the form of layers on the surface of the first substrate facing the second substrate, the electrode which is in electrical contact with the first conductor covering at least a partial region of the first conductor and the electrode which is in electrical contact with the third conductor covering at least a partial region of the third conductor, and
g. the separators of the single cells, which are also in the form of layers, are each in surface contact with one of the electrically connected electrodes with one of their sides and in surface contact with one of the electrically non-connected electrodes with the other of their sides.

Thus, the battery comprises at least two single cells connected in series, namely the first single cell and the second single cell. In some preferred embodiments, the battery comprises exactly two single cells connected in series, whereby it can be connected to an electrical load via the first and the third conductor. Thus, the battery preferably has a nominal voltage that is obtained by adding the voltages of the first and second single cells.

Areas of the first and third electrical conductors not coated with electrode material can serve as poles of the battery with the two single cells connected in series.

In a first, preferred embodiment, the battery is characterized by a combination of the immediately following additional features a. to d.:
a. In addition to the first and second single cells, it comprises an additional third single cell having a negative electrode, a positive electrode, and a separator disposed between the negative electrode and the positive electrode;
b. the three single cells are connected in series so that their voltages add up;
c. the third electrical conductor is in electrical contact with an electrode of the third single cell, the electrodes electrically connected by this conductor having an opposite polarity; and
d. the battery comprises a fourth electrical conductor electrically contacting the electrode of the third single cell not contacted by the third electrical conductor.

In this embodiment, the battery thus comprises at least three single cells, namely the first, the second and the third single cell. In some preferred embodiments, the battery comprises exactly three single cells connected in series, and the battery can preferably be connected to an electrical load via the first and fourth conductors. Thus, the battery preferably has a nominal voltage that is obtained by adding the voltages of the first and second and third single cells.

Areas of the first and fourth electrical conductors not coated with electrode material can serve as poles of the battery with the three single cells connected in series.

In a further development of the first, preferred embodiment, the battery is characterized by at least one of the immediately following additional features a. to d.:
a. The fourth electrical conductor is spaced from the second conductor on the surface of the second substrate facing the first substrate.
b. The electrode of the third single cell in contact with the third electrical conductor is arranged in the form of a layer on the first substrate, covering a partial area of the third conductor and separated by a gap from the further electrode arranged on the conductor.
c. The electrode of the third single cell, which is not in electrical contact with the third electrical conductor, is arranged in the form of a layer on the surface of the second substrate facing the first substrate and covers at least a partial area of the fourth electrical conductor.
d. The separator of the third single cell, which is also in the form of a layer, has one of its sides in surface contact with the electrode of the third single cell arranged on the fourth electrical conductor and the other of its sides in surface contact with the electrode of the third single cell arranged on the third electrical conductor.

Preferably, the immediately preceding features a. to d. are realized in combination with each other.

In a second, preferred embodiment, the battery is characterized by a combination of the immediately following additional features a. to d.:
a. It comprises, in addition to the first and second and third single cells, an additional fourth single cell having a negative electrode, a positive electrode, and the separator disposed between the negative electrode and the positive electrode.
b. The four single cells are connected in series so that their voltages add up.
c. The third electrical conductor is electrically in contact with an electrode of the third single cell, the electrodes electrically connected by this conductor having an opposite polarity, and the first electrical conductor is electrically in contact with an electrode of the fourth single cell, the electrodes electrically connected by this conductor also having an opposite polarity.
d. The battery includes a fifth electrical conductor that electrically contacts the remaining electrode of the fourth single cell.

In this embodiment, the battery thus comprises at least four single cells, namely the first, second, third and fourth single cells. In some preferred embodiments, the battery comprises exactly four single cells connected in series, and the battery can preferably be connected to an electrical load via the fourth and fifth conductors. Thus, the battery preferably has a nominal voltage that is obtained by adding the voltages of the first and the second and the third and the fourth single cells.

Areas of the fourth and fifth electrical conductors not coated with electrode material can serve as poles of the battery with the four single cells connected in series.

In a further development of the second, preferred embodiment, the battery is characterized by at least one of the immediately following additional features a. to g.:
a. The fifth electrical conductor is arranged in the form of a layer and spaced from the second and fourth electrical conductors on the surface of the second substrate facing the first substrate.
b. The electrode of the third single cell in contact with the third electrical conductor is arranged in the form of a layer on the first substrate, covering a partial area of the third conductor and separated by a gap from the further electrode arranged on the third electrical conductor.
c. The electrode of the third single cell in contact with the fourth electrical conductor is arranged in the form of a layer on the surface of the second substrate facing the first substrate and covers at least a partial area of the fourth electrical conductor.
d. The electrode of the fourth single cell in contact with the first electrical conductor is arranged in the form of a layer on the first substrate, covering a partial area of the first conductor and separated by a gap from the further electrode arranged on the first electrical conductor.
e. The electrode of the fourth single cell, which is not electrically in contact with the first electrical conductor, is arranged in the form of a layer on the surface of the second substrate facing the first substrate and covers at least a partial area of the fifth electrical conductor.
f. The separator of the third single cell, which is also in the form of a layer, has one of its sides in surface contact with the electrode of the third single cell arranged on the fourth electrical conductor and the other of its sides in surface contact with the electrode of the third single cell arranged on the third electrical conductor.
g. The separator of the fourth single cell, which is also in the form of a layer, has one of its sides in surface contact with the electrode of the fourth single cell arranged on the first electrical conductor and the other of its sides in surface contact with the electrode of the fourth single cell arranged on the fifth electrical conductor.

Preferred are the immediately preceding features a. to g. realized in combination with each other.

In a third, preferred embodiment, the battery comprises n further single cells which are connected in series with the first to fourth single cells, where n is preferably an integer in the range from 1 to 100. The battery thus preferably has a nominal voltage which is obtained by adding the voltages of the first to fourth and the n further single cells.

The n further single cells are preferably designed like the first to fourth single cells. They each have layered electrodes and a layered separator, one side of the separator being in surface contact with one of the electrodes of the respective n'th single cell and the other side being in surface contact with the other electrode.

For each additional single cell, the battery preferably comprises another electrical conductor contacting one of the electrodes of the additional single cell.

It is preferred that the single cells of a battery formed as a layer stack each have the same nominal voltage and the same nominal capacity.

It follows from the above that the single cells of the battery each comprise a stack of layered electrodes and a layered separator. One of the sides of the separators has a first contact surface to the positive electrode of the respective single cell, the other side parallel thereto has a second contact surface to the negative electrode. Preferably, the contact surfaces overlap each other in the direction of a view perpendicular to the respective separator in an overlay region A, in which a straight line perpendicular to the separator intersects both contact surfaces.

With identical area dimensions of oppositely poled electrodes and non-staggered arrangement of positive and negative electrode within a stack, the size of the overlay area A preferably corresponds exactly to the size of the electrodes.

The stacked arrangement of electrodes and separator has proven superior to a coplanar arrangement as in the case of the electrodes of the cell described in US 2010/081049 A1. The current-carrying capacity of cells with stacked electrodes is significantly higher, since the ions that travel back and forth between the electrodes during charging and discharging processes have to cover significantly shorter distances on average. In the superposition region A, the shortest distance between the electrodes in many cases corresponds approximately to the thickness of the separator arranged between the positive and negative electrodes.

It is preferred that electrodes electrically connected via the second conductor and, in the case of the second or the third preferred embodiment, also via further conductors arranged on the second substrate are in full-surface contact with the respective conductor with their side facing the second substrate. The side of electrodes facing the second substrate, which are electrically connected via a conductor arranged on the second substrate, thus preferably does not have any areas which are not in direct contact with this conductor.

The same applies in the case of the second or the third preferred embodiment also to the conductors arranged via the first and/or the third and/or other conductors arranged on the first substrate, via which electrodes are electrically connected. The side of electrodes facing the first substrate, which are electrically connected via a conductor arranged on the first substrate, thus preferably does not have any regions which are not in direct contact with this conductor.

In a variant preferred in all embodiments, the cell stacks of the battery comprise two electrodes, a positive electrode and a negative electrode, which are not electrically connected via an electrical conductor to an electrode of an adjacent single cell and via which the total voltage of the battery can be tapped. In the case of the second, preferred embodiment, this is, for example, one of the electrodes of the third and one of the electrodes of the fourth single cell, which are in electrical contact with the fourth and the fifth conductor.

It is preferred that such electrodes, which are in electrical contact with a conductor on the first or the second substrate but are not in electrical contact with an electrode of reversed polarity via this conductor, are in contact with this conductor over their entire surface. The side of these electrodes facing the respective substrate thus preferably has no areas that are not in direct contact with this conductor.

However, in principle it is possible to contact electrodes not electrically connected to other electrodes via more than one electrical conductor. For example, in the case of the second, preferred embodiment, the fifth electrical conductor could be divided into two or more separate subregions, which are arranged next to each other on the respective substrate. In this case, it would be preferred to contact the respective electrode over as large an area as possible by means of the two or more separate subregions in order to come as close as possible to the goal of full-area contacting. Currents tapped via the partial areas can be recombined by means of a corresponding electrical connection between the partial areas.

It is also preferred that electrodes which are in electrical contact with a conductor on the first or the second substrate, but which are not in electrical contact with an electrode of reversed polarity via this conductor, are in contact with the separators of the respective single cells over their entire surface with their side facing away from the respective substrate. The side of the electrodes facing away from the respective substrate therefore preferably has no areas that are not in direct contact with the respective separator.

In preferred further embodiments, the battery is characterized by at least one of the immediately following features a. to d.:
a. The electrical conductors that electrically connect two electrodes form an electrically conductive area on the surface of the respective substrate that is larger than the area occupied by the electrically connected electrodes on the surface.
b. This electrically conductive area and the electrodes electrically connected thereabove overlap in the direction of a view perpendicular to the electrodes and the conductor in an overlay area B, the overlay area B preferably being at least 80%, preferably at least 90%, especially 100% of the area of the electrically connected electrodes.
c. The electrically conductive area on the respective substrate includes at least one area which is not included in the overlay area B and in which there is no overlay with the connected electrodes.
d. The area not encompassed by the overlay area extends across the gap separating the connected electrodes.

Preferably, the immediately preceding features a. and b. as well as features c. and d. are realized in combination with each other. Preferably, features a. to d. are realized in combination with each other.

For example, in the case of the second, preferred embodiment, the conductors according to the immediately preceding features a. to d. are the first, the second and the third conductor.

The overlay area B here refers to the area in which a straight line perpendicular to the electrodes intersects both the electrodes and the electrically connecting conductor. Preferably, the electrodes electrically connected via the conductor are thus in contact with this electrical conductor over the entire surface.

The edges of the two electrically connected electrodes define the areas that the electrodes occupy on the respective substrate. For each of the two electrically connected electrodes, at least a partial section of the respective edge faces the corresponding oppositely poled electrode. In this context, the section of the edge of an electrode “facing the oppositely poled electrode” is to be understood as the section of the edge of an electrode in which the edge can be connected by a straight line to the edge of the oppositely poled electrode without intersecting the edges of the electrodes. It is preferred that these portions of the edges also define the gap between the electrodes. More precisely, preferably, the gap by which the two electrodes are separated is defined as the largest possible area on the respective substrate not covered with electrode material that can be enclosed by straight lines between the edges connecting the edges of the two electrodes without intersecting any of the edges.

In further preferred embodiments, the battery is characterized by at least one of the immediately following features a. and b.:
a. The electrical conductors, which are in electrical contact with only one of the electrodes and do not connect it to an electrode of reversed polarity, form an electrically conductive area on the surface of the respective substrate that is larger than the area occupied by the electrically contacted electrode on the surface.
b. These conductors and the electrode contacted in each case overlap in the direction of view perpendicular to the electrodes and the conductor in an overlay region C, the overlay region C preferably being at least 80%, preferably at least 90%, especially 100% of the area of the electrodes.

Preferably, the immediately preceding features a. and b. are realized in combination with each other.

For example, in the case of the second, preferred embodiment, these conductors are the fourth and fifth conductors.

In the case of only two single cells, only the second conductor can be designed in this way.

The overlay area C here refers to the area in which a straight line perpendicular to the electrodes intersects both the electrodes and the electrically connecting conductor. Preferably, the electrodes electrically connected via the conductor are thus in contact with this electrical conductor over the entire surface.

A non-100% overlap of the electrodes with the conductors may result, for example, if, as mentioned above, the conductor or conductors are divided into two or more separate sub-areas.

In a preferred further development, the battery is characterized by the immediately following feature a.:
a. The electrical conductors that electrically connect two electrodes to each other are formed as a continuous electrically conductive layer at least in some areas, preferably over the entire area they occupy on the respective substrate.

Preferably, this applies both to the areas of the electrical conductors overlapping in the overlay area B with the electrodes electrically connected via the electrical conductors and to the gap between the connected electrodes.

With reference to the second, preferred embodiment, this means that the first, second and third electrical conductors are preferably each formed as a continuous electrically conductive layer. Preferably, the electrodes thus do not touch anywhere the substrate on which they are arranged. Instead, they preferably lie directly on the respective electrical conductor.

In a further, preferred further development, the battery is characterized by the immediately following feature a.:
a. The electrical conductors which electrically connect two electrodes to one another are formed at least in some areas, preferably over the entire area which they occupy on the respective substrate, from lines and/or tracks, wherein preferably at least 10% and preferably at most 90%, further preferably at most 75%, further preferably at most 50%, preferably at most 25%, of the area of the respective substrate occupied by the respective electrical conductors is covered by the lines and/or tracks.

Again, this preferably applies both to the areas of the electrical conductors overlaid in the overlay area B with the electrodes electrically connected via the electrical conductors and to the gap between the connected electrodes.

Preferably, the lines and/or tracks are aligned in parallel and/or in a crossed arrangement.

Between the electrically connected electrodes, the respective substrate on which the conductor is arranged is preferably covered over its entire surface by the respective electrical conductor. This serves to ensure that the cross-section of the electrical conductor within the gap is as large as possible, which in turn has a positive effect on the impedance of the battery.

Of course, embodiments of the battery can also be realized in which one of the electrical conductors electrically connecting two electrodes to one another is formed as a continuous electrically conductive layer at least in some areas, preferably over the entire area which it occupies on the respective substrate, while another of the electrical conductors electrically connecting two electrodes to one another is formed at least in some areas, preferably over the entire area which it occupies on the respective substrate, preferably over the entire area which it occupies on the respective substrate, is formed from lines and/or tracks which can be aligned in the described parallel and/or crossed arrangement, wherein preferably at least 10% and preferably at most 90%, further preferably at most 75%, further preferably at most 50%, preferably at most 25%, of the area of the respective substrate occupied by the respective electrical conductor is covered by the conductor.

It is preferred that the battery is characterized by at least one of the immediately following additional features a. to i.:
a. The electrodes are rectangular or in the form of strips.
b. The gap between electrically connected electrodes has a substantially constant width.
c. Oppositely poled electrodes of the single cells occupy the same area on the substrates.
d. The electrically connected electrodes and the electrically non-connected electrodes are aligned parallel to each other.
e. Equally poled electrodes of the single cells have essentially identical dimensions.
f. The electrodes have
   a length in the range of from 1 cm to 25, preferably from 5 cm to 20 cm, and
   a width in the range from 0.5 to 10 cm, preferably from 1 cm to 5 cm.
g. The gap has
   a length in the range of from 1 cm to 25, preferably from 5 cm to 20 cm, and
   a width in the range of o.1 cm to 2 cm, preferably from 0.2 cm to 1 cm.
h. The electrical conductors have a thickness in the range from 2 μm to 250 μm, preferably from 2 μm to 100 μm, preferably from 2 μm to 25 μm, more preferably from 5 μm to 10 μm.
i. The electrodes have a thickness in the range of 10 μm to 350 μm.

Preferably, the immediately preceding features a. to i. are realized in combination with each other.

The positive and negative electrodes each have a preferred thickness in the range from 10 μm to 250 μm. The positive electrode is often somewhat thicker than the negative electrode, since in many cases the latter has a higher energy density. Thus, in some applications, it may be preferred to form the negative electrode as a layer with a thickness of 30 μm to 150 μm and the positive electrode as a layer with a thickness of 180 to 350 μm. By adjusting the thicknesses, the capacitances of the positive and negative electrodes can be balanced. In this regard, it is preferred that the positive electrode be oversized relative to the negative electrode.

Furthermore, it is preferred that the battery is characterized by at least one of the immediately following additional features a. and b.:
a. It comprises a housing enclosing the single cells and comprising first and second housing insides, wherein the first and second substrates are part of the housing and the first housing inside is a surface of the first substrate and the second housing inside is a surface of the second substrate.
b. The first and second substrates are films or components of a film.

Here, too, the immediately preceding features a. and b. are preferably realized in combination with each other.

It is preferred that the battery, including the housing, has a maximum thickness in the range of a few millimeters, preferably in the range of 0.5 mm to 5 mm, more preferably in the range of 1 mm to 3 mm. Its other dimensions depend on the number of electrically connected single cells and their dimensions. For example, a battery with four serially connected single cells may have a length of 5 to 20 cm and a width of 4 to 18 cm.

In some preferred embodiments, the battery is a printed battery. In the present context, a printed battery is to be understood as a battery in which at least the electrodes, optionally also the electrical conductors, in some preferred embodiments also the separator and optionally further functional parts, are formed by printing a printing paste onto a carrier, in particular by means of a screen printing process. Preferably, the electrodes and the electrical conductors, in particular the first and the second electrical conductors, are printed.

Accordingly, the battery is preferably characterized by at least one of the following features a. to c.:
a. The electrodes of the single cells are formed by a printing process.
b. The electrical conductors are formed by a printing process.
c. The separators of the single cells are formed by a printing process.

Preferably, the immediately preceding features a. to c. are realized in combination with each other.

From an electrochemical point of view, the battery is not limited. The single cells can be cells with an organic electrolyte, for example lithium-ion cells, or cells with an aqueous electrolyte.

Preferably, the single cells of the battery are characterized by at least one of the following features a. and b.:
a. The negative electrodes of the single cells comprise particulate metallic zinc or particulate metallic zinc alloy as electrode active material.
b. The positive electrodes of the single cells comprise a particulate metal oxide, in particular particulate manganese oxide, as the electrode active material.

The single cells of the battery are therefore preferably zinc manganese oxide cells.

In an alternative preferred embodiment, the single cells of the battery are zinc-silver oxide cells. Their negative electrodes comprise particulate metallic zinc or a particulate metallic zinc alloy as electrode active material, while their positive electrodes comprise particulate silver oxide as electrode active material.

In all cases, the particulate metallic zinc or the particulate metallic zinc alloy is present in the negative electrodes of the single cells, based on the total weight of the solid components of the negative electrodes, preferably in a proportion in the range from 40% to 99% by weight, in particular from 40% to 80% by weight.

The choice of an electrochemical system with a zinc-based negative electrode is primarily due to the required safety. Systems with zinc-based negative electrodes require an aqueous electrolyte and are therefore non-flammable. In addition, zinc is environmentally compatible and cheap.

In order to provide a battery with single cells with zinc-containing negative electrodes with the required current-carrying capacity, it is advantageous to implement at least one of the immediately following features a. to d.:
a. The positive electrodes of the single cells contain, in a preferably homogeneous mixture, at least one conductivity additive for optimizing the electrical conductivity of the positive electrodes and/or an elastic binder or binder mixture in addition to the electrode active material.
b. The particulate metal oxide is preferably present in the positive electrodes in a proportion of 10% to 90% by weight, based on the total weight of the solid components of the positive electrodes.
c. The positive electrodes of the single cells contain the elastic binder or binder mixture in a proportion of 1 wt. % to 25 wt. %, based on the total weight of the solid components of the positive electrodes.
d. The positive electrodes of the single cells contain the at least one conductivity additive in a proportion of 1 wt. % to 85 wt. %, based on the total weight of the solid components of the positive electrodes.

Preferably, the immediately preceding features a. to d. are realized in combination with each other.

The proportion of the elastic binder or binder mixture in the positive electrodes should preferably be at least 1% by weight, since it is intended to fix the metal oxide particles contained relative to one another and at the same time give the positive electrodes a certain flexibility. However, the proportion should not exceed the above-mentioned maximum proportion, as otherwise there is a risk that the metal oxide particles will no longer be in contact with each other, at least in part. Within the above-mentioned range, a proportion in the range from 1 wt. % to 15 wt. %, preferably from 5 wt. % to 15 wt. %, is further preferred.

Within the above range for the particulate metal oxide, a proportion in the range of 50 wt % to 90 wt % is further preferred.

Within the range mentioned above for the at least one conductivity additive, a proportion in the range of 2.5% to 35% by weight is further preferred.

A high proportion of the metal oxide in the positive electrodes increases the capacity of the battery. For the current-carrying capacity, however, the proportion of the at least one conductivity additive is of greater importance than the total proportion of metal oxide.

In principle, all percentages by weight of components in electrodes in the present application refer to the total weight of the solid components of the respective electrode. The weight fractions of the components involved in each case add up to 100% by weight. Before determining them, any moisture contained in the electrodes must be removed.

In the case of a battery with single cells with zinc-containing negative electrodes, it is further preferred that the negative electrodes of the single cells also contain an elastic binder or binder mixture in a preferably homogeneous mixture in addition to the particulate metallic zinc or the particulate metallic zinc alloy.

Regarding the choice of a suitable conductivity additive, two preferred variants are available.

In a first preferred variant, the battery is characterized by at least one of the immediately following additional features a. and b.:
a. The positive electrodes contain at least one carbon-based material as a conductivity additive, particularly selected from the group consisting of activated carbon, activated carbon fiber, carbide-derived carbon, carbon aerogel, graphite, graphene, and carbon nanotubes (CNTs).
b. The positive electrodes contain the at least one carbon-based material in an amount in the range of 25% to 35% by weight (see above).

In preferred embodiments of the battery, the immediately preceding features a. and b. are realized in combination with each other.

In this variant, one takes advantage of the fact that the specified conductivity additives not only increase the electrical conductivity of the positive electrodes but can also give the positive electrodes a double-layer capacitance in addition to their Faraday capacitance. This means that very large currents can be made available for short periods.

Surprisingly, it has been found that a similar positive effect can be achieved by adding conducting salts to the positive electrodes during their manufacture via an electrode paste, which can crystallize as the positive electrodes dry. When the electrodes are later impregnated with an electrolyte, the crystalline conducting salts can be wetted very quickly and lead to better penetration of the electrodes with an ion-conducting liquid.

Accordingly, in a second preferred embodiment, the battery is characterized by at least one of the immediately following additional features a. and b.:
a. The positive electrodes contain at least one water-soluble salt as a conductivity additive.
b. The positive electrodes contain the at least one water-soluble salt in an amount ranging from 1 wt % to 25 wt %.

In preferred embodiments of the battery, the immediately preceding features a. and b. are realized in combination with each other.

As a water-soluble salt, in particular halides can be added to the positive electrodes for the purpose of improving electrical conductivity, preferably chlorides, especially zinc chloride and/or ammonium chloride.

In some preferred embodiments, the listed variants may also be combined. In these cases, the battery is characterized by a combination of the immediately following features a. and b.:
a. The positive electrodes include as a first conductivity additive the at least one carbon-based material, particularly selected from the group consisting of activated carbon, activated carbon fiber, carbide-derived carbon, carbon aerogel, graphite, graphene, and carbon nanotubes (CNTs).
b. The positive electrodes contain the at least one water-soluble salt as a second conductivity additive.

If necessary, the negative electrodes of the single cells can also contain a proportion of a conductivity additive. However, since the active material of the negative electrodes is already electrically conductive by itself, this is not absolutely necessary.

Also with regard to the choice of a suitable binder or binder mixture, some variants are preferred.

In preferred embodiments, the battery is characterized by at least one of the immediately following additional features a. and b.:
a. The negative electrodes of the single cells contain as elastic binder or binder mixture at least one member selected from the group consisting of cellulose and its derivatives, in particular carboxymethyl cellulose (CMC), polyacrylates (PA), polyacrylic acid (PAA), polychlorotrifluoroethylene (PCTFE), polyhexafluoropropylene (PHFP), polyimides (PI), polytetrafluoroethylene (PTFE), polytrifluoroethylene (PTrFE), polyvinyl alcohol (PVA), polyvinylidene difluoride (PVDF), styrene-butadiene rubber (SBR), and mixtures of the above materials.
b. The positive electrodes of the single cells contain as elastic binder or binder mixture at least one member selected from the group comprising cellulose and its derivatives, in particular carboxymethyl cellulose (CMC), polyacrylates (PA), polyacrylic acid (PAA), polychlorotrifluoroethylene (PCTFE), polyhexafluoropropylene (PHFP), polyimides (PI), polytetrafluoroethylene (PTFE), polytrifluoroethylene (PTrFE), polyvinyl alcohol (PVA), polyvinylidene difluoride (PVDF), styrene-butadiene rubber (SBR) and mixtures of the above materials.

In preferred embodiments of the battery, the immediately preceding features a. and b. are realized in combination with each other.

Preferably, both the positive and the negative electrodes contain as binder or binder mixture a combination of a polysaccharide suitable as electrode binder, in particular a cellulose derivative, and SBR. For example, the positive and negative electrodes may contain 0.5% to 2.5% by weight of carboxymethyl cellulose and/or chitosan and 5% to 10% by weight of SBR. The cellulose derivative and/or the chitosan also serve as emulsifiers in this case. They help to distribute the elastic binder (SBR) in the paste.

The positive and negative electrodes of the single cells of the battery contain the elastic binder or binder mixture, based on the total weight of their solid components, preferably in a proportion of 1% to 25% by weight.

The single cells of the battery preferably comprise a liquid electrolyte with which the separator and the electrodes are impregnated. In the case of single cells with particles of zinc or a zinc alloy in the negative electrode, this is an aqueous electrolyte.

In many embodiments, alkaline electrolytes, for example sodium hydroxide solution or potassium hydroxide solution, are well suited. However, aqueous electrolytes with a pH in the neutral range have the advantage of being less hazardous in the event of mechanical damage to the battery.

In a preferred embodiment, the single cells of the battery are preferably characterized by at least one of the immediately following additional features a. and b.:
a. They comprise an aqueous electrolyte containing a chloride-based conducting salt,
b. The separators placed between the positive and negative electrodes are impregnated with the electrolyte.

In preferred embodiments of the battery, the immediately preceding features a. and b. are realized in combination with each other.

Zinc chloride and ammonium chloride are particularly suitable as chloride-based conducting salts. It is preferred that the pH of the aqueous electrolyte is in the neutral or slightly acidic range.

It has already been mentioned that in some preferred embodiments the separators of the single cells of the battery can be printed. Suitable printing pastes for this purpose can be found, for example, in EP 2 561 564 B1.

In further embodiments, however, the separators can also be porous sheet materials, for example porous films or nonwovens, which are arranged between the electrodes. Suitable sheet materials and corresponding procedures are described in EP 3 477 727 A1.

A nonwoven or a microporous plastic film with a thickness in the range of 60 to 120 μm and a porosity (ratio of void volume to total volume) in the range of 35-60% is preferred as a porous sheet. The nonwoven or film is preferably made of a polyolefin, for example polyethylene.

In particular, if porous sheet structures such as the aforementioned films and nonwovens are used as separators, it may be preferred that the single cells of the battery have a common separator. For example, in the case of the second, preferred embodiment of the battery, a porous film may have four regions separated from one another, via which the oppositely poled electrodes of the four layer stacks are connected. In embodiments having two single cells, the porous film may have two regions separated from each other through which the oppositely poled electrodes of the four layer stacks are in communication. This can significantly simplify the production of the battery.

Instead of a separator-liquid electrolyte combination as described above, a solid electrolyte can in principle also be arranged between the electrodes, as described in a preferred embodiment, for example, in EP 2 960 967 B1. However, variants in which a liquid electrolyte is used are preferred in many cases.

In some preferred embodiments, the aqueous electrolyte comprises an additive to increase the viscosity (actuator) and/or mineral filler particles, in particular in an amount such that the electrolyte has a paste-like consistency. Such an electrolyte is also referred to below as an electrolyte paste.

Silicon dioxide is particularly suitable as an actuating agent. However, binding substances such as carboxymethyl cellulose can also be used to increase viscosity.

Suitable mineral filler particles include ceramic solids, salts that are almost or completely insoluble in water, glass and basalt, and carbon. The term “ceramic solids” is intended to cover all solids that can be used to manufacture ceramic products, including silicate materials such as aluminum silicates, glasses and clay minerals, oxide raw materials such as silicon dioxide, titanium dioxide and aluminum oxide, and non-oxide materials such as silicon carbide or silicon nitride.

The mineral filler particles preferably exhibit electrically insulating properties.

In the context of the present application, the term “virtually or completely insoluble” means that there is at most a low solubility in water at room temperature, preferably none at all. For this purpose, the solubility of the mineral filler particles, in particular of the salts mentioned which are virtually or completely insoluble in water, should ideally not exceed the solubility of calcium carbonate in water at room temperature. Incidentally, calcium carbonate is a preferred example of an inorganic solid which can be included as a particulate filler component in the electrolyte paste.

In preferred embodiments, the electrolyte paste has the following composition:

| | |
|---|---|
| Chloride-based conducting salt | 30-40 wt. % |
| Floating agent (e.g. SiOx powder) | 2 to 4 wt. % |
| Mineral particles (e.g. CaCO₃) | 10 to 20 wt. % |
| Solvent (preferably water) | 40 to 55 wt. % |

Zinc chloride and/or ammonium chloride are also preferably used here as chloride-based conducting salt.

In some preferred embodiments, it has proved advantageous with regard to the impedance properties of the battery to arrange a layer of such an electrolyte with a paste-like consistency (in short: electrolyte layer) between the separator and at least one of the electrodes of the single cells, preferably between both sides of the separator and the electrodes of the single cells in each case a layer of this electrolyte. If a layer of such an electrolyte is applied to one of the sides or both sides of the separator, the water and components of the electrolyte dissolved therein penetrate into the separator, whereas the suspending agent and/or the mineral filling particles remain as a layer on the side or sides of the separator. The same applies if the electrolyte with the paste-like consistency is applied to the electrodes.

Since the electrolyte layers help to electrically isolate the positive electrode and the negative electrode from each other through their content of mineral filler particles, they can be regarded as optional components of the separator. In preferred embodiments, the separators of the single cells thus also comprise one or two such electrolyte layers.

The electrical conductors of a battery can, for example, be metallic structures formed by means of deposition from a solution, by means of deposition from the gas phase (for example, by a PVD process such as sputtering) or by a printing process. It is also possible to form the conductors from a closed metal layer by an etching process in which the metal layer is removed in unmasked areas.

In preferred embodiments, the battery is characterized by the following additional feature a:
a. The battery comprises as electrical conductors conductors made of metal particles, in particular silver particles or particles made of a silver alloy.

Such conductive paths can be easily produced using a printing process. Printable conductive pastes with silver particles for producing the electrical conductors are state of the art and freely available in the trade.

In preferred embodiments, the battery is characterized by the immediately following features:
a. The electrical conductors include an electrically conductive metal layer.
b. The electrical conductors comprise, at least in some areas, an electrically conductive layer of carbon, which is arranged between the metal layer and the electrodes and which makes direct contact of the metal layer with a liquid electrolyte difficult or even prevents it.

The electrically conductive layer of carbon serves to protect the electrical conductors. In particular, if the conductors include silver particles, there is a risk that silver will dissolve in the electrolyte, resulting in weakening or even destruction of conductive paths. The carbon layer can protect the conductors made of silver from direct contact with the electrolyte.

Preferably, the electrically conductive layer of carbon has a thickness in the range of 5 μm to 30 μm, in particular in the range of 10 μm to 20 μm.

In some preferred embodiments, the carbon layer is subjected to a heat treatment after application, thereby increasing its impermeability.

A method of manufacturing a battery such as that described above is preferably characterized by the steps a. through e. immediately below:
a. Applying first and third electrical conductors to a first electrically non-conductive substrate and a second electrical conductor to a second electrically non-conductive substrate.
b. Applying a layered first negative electrode directly to the first electrical conductor and a layered first positive electrode directly to the third electrical conductor.
c. Applying a layered second negative electrode and a layered second positive electrode directly to the second electrical conductor so that the second electrodes are separated from each other by a gap.
d. Applying a layered separator to the first negative electrode or the second positive electrode and a layered separator to the second negative electrode or the first positive electrode.
e. Forming two layer stacks with the sequence
   first negative electrode/separator/second positive electrode, and
   second negative electrode/separator/first positive electrode.

Possible designs of the conductors and electrodes have already been discussed in connection with the battery. Reference is hereby made to the corresponding explanations.

The application of the conductors and the electrodes is preferably carried out by means of a printing process, in particular by screen printing. The separator can also be applied by a printing process, as described above. Preferably, however, a nonwoven or film separator is arranged between the electrodes of the layer stacks.

To convert the layer stacks into operational electrochemical cells, it is usually necessary to impregnate the electrodes and the separators with the liquid electrolyte described above. This can be done before and/or after the application of the separators.

In a further development, it is preferred that the layer of electrolyte with a paste-like consistency described above is arranged between the separators and the electrodes. For this purpose, the electrolyte can, for example, be printed onto the electrodes before the layer stack is formed.

In a first alternative, preferred embodiment, the method is characterized by the immediately following steps a. to d.:
a. Before applying the separator to either the first negative electrode or the second positive electrode, a first layer of an electrolyte paste is printed on the selected electrode, in particular with a thickness of 30 to 70 μm.
b. Before applying the separator to either the second negative electrode or the first positive electrode, a second layer of an electrolyte paste is printed on the selected electrode, in particular with a thickness of 30 to 70 μm.
c. The separators are applied to the first and second layers of the electrolyte paste.
d. After the separators have been applied, a second layer of the electrolyte paste is printed on each of the separators, in particular with a thickness of 30 to 70 μm.

In a second alternative, preferred embodiment, the method is characterized by the following features:
a. Before applying the separator to either the first negative electrode or the second positive electrode, a first layer of an electrolyte paste is printed on each of the electrodes, in particular with a thickness of 30 to 70 μm.
b. Before applying the separator to either the second negative electrode or the first positive electrode, a second layer of an electrolyte paste is printed on each of the electrodes, in particular with a thickness of 30 to 70 μm.
c. The separators are either applied to the first or the second layer of the electrolyte paste.
d. The layer stacks are formed so that on one side of the separators is the first layer and on the other side of the separators is the second layer of the electrolyte.

In layer stacks produced in this way, one of the layers of electrolyte paste is always arranged between the electrodes and the separators. Or in other words: The separators of layer stacks produced in this way each comprise layers of the electrolyte paste on both sides.

As has already been described in connection with the battery, it may be preferred that two or more single cells of the battery have a common separator. In the context of the described process, the separators optionally applied to the first negative electrode or the second positive electrode or the second negative electrode or the first positive electrode are in such cases mutually separated regions of a porous sheet structure as described above, for example mutually separated regions of a microporous polyolefin film.

Consequently, in such cases, the electrolyte paste in the first alternative, preferred embodiment is not applied to several separate separators but to separate areas of the same sheet.

Preferably, before impregnation with the liquid electrolyte and/or before application of the electrolyte with the paste-like consistency to the first and second substrates, a plurality of sealing frames are formed or arranged to enclose the electrodes. These sealing frames ensure that liquid applied to the electrodes does not run on the substrates. Possible embodiments of the sealing frame and variants for its formation are known from EP 3 477 727 A1.

Preferably, the sealing frame is formed from an adhesive mass which can be applied by a printing process. In principle, any adhesive can be used that is resistant to the electrolyte used and can form a sufficient bond to the substrate. In particular, the sealing frame can also be formed from a dissolved polymer composition, the solvent contained in which must be removed in order to solidify it.

It is also possible to form the sealing frame from a thermoactivatable film, in particular a fusible film or a self-adhesive film.

In addition to the respective solid components, printing pastes that can be used to manufacture the electrodes and conductors also preferably contain a volatile solvent or suspending agent. Ideally, this is water. To avoid problems during printing, the printing pastes preferably contain all particulate components with particle sizes of 50 μm or less.

As described above, the electrical conductors are preferably coated with the electrically conductive layer of carbon before the electrodes are applied to protect the conductors from direct contact with the electrolyte. The layer of carbon can also be printed on.

Preferred Combinations of Features

To transmit an LTE message, scanning first takes place. During this process, the tag searches for possible frequencies for the data transmission. This process takes an average of 2 s and requires 50 mA. When the frequency is found, a so-called TX pulse is sent. Such a pulse lasts about 150 ms and requires an electrical current pulse of about 200 mA. A pulse with a length of 150 ms corresponds approximately to a frequency of 4 Hz. Accordingly, the impedance of the battery at 4 Hz is important for the transmission of such a pulse.

In the case of printed single cells of batteries, particularly good results can be achieved in this context if the compositions of the electrodes as well as the composition of the electrolyte are matched. Preferably, the following paste compositions are used in combination to produce the electrodes and electrolyte layers of batteries:

Paste for the Negative Electrode:

| | |
|---|---|
| Zinc powder (mercury-free): | 65-79 wt. % |
| Emulsifier (e.g. CMC) | 1-5 wt. % |
| Binder, elastic (e.g. SBR) | 5-10 wt. % |
| Solvent (e.g. water) | 15-20 wt. % |

Paste for the positive electrode:

| | |
|---|---|
| Manganese dioxide | 50-70 wt. % |
| Conductive material (e.g. graphite, carbon black) | 5-8 wt. % |
| Emulsifier (e.g. CMC) | 2-8 wt. % |
| Binder, elastic (e.g. SBR) | 8-15 wt. % |
| Solvent (e.g. water) | 20-30 wt. % |

Electrolyte paste

| | |
|---|---|
| Conducting salt zinc chloride | 30-40 wt. % |
| Floating agent (e.g. silicon oxide powder) | 2-4 wt. %. |
| Mineral particles (e.g. CaCO )₃ | 10-20 wt. % |
| Solvent (e.g. water) | 40-55 wt. % |

It is preferred that proportions of the individual components in the pastes each add up to 100% by weight. The proportions of the non-volatile components in the electrodes can be calculated from the corresponding percentages of the pastes. For example, the percentages of zinc and the elastic binder in a negative electrode prepared from the above paste range from 81.25 wt % to 92.94 wt % (zinc) and 5.62 wt % to 13.16 wt % (elastic binder). The proportions of manganese dioxide and the elastic binder in a positive electrode prepared from above paste range from 61.72 wt % to 82.35 wt % (manganese dioxide) and 8.51 wt % and 20.83 wt % (elastic binder).

The electrolyte paste is preferably used in combination with a microporous polyolefin film (e.g. PE) with a thickness in the range of 60 to 120 μm and a porosity of 35-60%. Preferably, according to the above first or second alternative, preferred embodiment, layers of the electrolyte paste are formed on the electrodes and/or the separator, in particular with a thickness in the specified ranges, preferably each with a thickness of about 50 μm. The anode is preferably printed as a layer with a thickness of 30 μm to 150 μm, in particular with a thickness of 70 μm. The positive electrode is preferably printed as a layer with a thickness of 180 to 350 μm, in particular with a thickness of 280 μm.

In a further preferred embodiment of the method, it is characterized by at least one of the immediately following additional features and/or steps a. and b.:
a. The first and second substrates are different areas of the same substrate.
b. To form the layer stack, the carrier is folded over so that the first negative electrode is superimposed on the first separator and the second positive electrode, and the second negative electrode is superimposed on the second separator and the first positive electrode, the folding over and subsequent welding and/or bonding forming a closed container in which the layer stack is arranged.

In preferred embodiments of the method, the immediately preceding features a. and b. are realized in combination with each other.

As already mentioned, in a process according to an aspect of the present disclosure, layer stacks with the sequence negative electrode/separator/positive electrode are formed. This can preferably be done by printing the electrodes of a cell next to each other, i.e. in a coplanar arrangement, on the carrier and folding over or folding the carrier in such a way that the electrodes and the associated separator of each single cell are superimposed. After folding over, the carrier encloses the resulting layer stack from at least three sides. A closed container can be formed by welding and/or bonding the remaining sides. Bonding is also particularly suitable if the anode and cathode have previously been surrounded by the aforementioned adhesive frame. In this case, the sealing frame can bring about the bonding.

The process described herein leads directly to a battery with two single cells electrically connected in series. The production of batteries with three, four or more single cells electrically connected in series requires the provision of additional electrodes, separators and conductors, but the process does not require any additional steps in these cases. For example, all electrical conductors can be printed in one process step, regardless of their number. The same applies to the electrodes and the electrolyte layers.

For the above-described embodiment second, preferred embodiment with four single cells requires approximately an additional fourth and fifth electrical conductor on the second substrate and two additional positive and negative electrodes to form two additional single cells.

A radio tag according to an aspect of the present disclosure comprises a transmitter and/or receiver unit for transmitting and/or receiving radio signals and a battery for supplying the transmitter and/or receiver unit with an electric current, wherein the battery is formed according to the above embodiments. Preferably, the transmitter and/or receiver unit and the battery are arranged on a carrier. The battery is preferably designed to supply the transmitter and/or receiver unit with an electric current of ≥400 mA at peak.

Preferably, the battery associated with a radio tag is designed according to the second, especially preferred embodiment described above, i.e. it has four single cells connected in series. These are preferably zinc manganese oxide cells.

To measure a peak current deliverable by a battery, it is preferred to derive the impedance of the battery from the electrochemical impedance spectrum (EIS). In this measurement method, the impedances Z are determined as a function of the measurement frequency f, Z=Z(f). The impedance value Z(0.5 Hz) best corresponds to the load caused by a pulse current with a length of 1 s. This is calculated with the voltage difference between the open-circuit voltage and the closing voltage of the electronic application according to Ohm's law.

Peak current i=voltage difference ΔU/Z(0.5 Hz)

In preferred embodiments, the single cells of the battery may be formed directly on the substrate. As explained above, the first and second substrates can be areas on one and the same carrier, so that it is then possible to apply the electrical conductors and the electrodes of the battery in a coplanar arrangement on the carrier and to turn the carrier over in such a way that the negative and positive electrodes of the cells are each superimposed with a separator and the single cells of the battery, which are formed as a layer stack, are formed. The carrier encloses the resulting layer stack from at least three sides after the overturning. A closed container can be formed by welding and/or bonding the remaining sides.

However, it may also be preferred to manufacture the battery separately and fix it to the carrier, for example by means of an adhesive.

With regard to possible preferred embodiments of the radio tag, reference is hereby made to WO 2019/145224 A1. There, for example, a sensor system is described in detail, which can be part of the radio tag and with the aid of which status information about a product labeled with the radio tag can be determined.

In the context described here, the carrier and the transmitter and/or receiver unit are of particular importance. The latter is preferably a mobile communication chip as mentioned at the beginning, in particular a chip that is capable of data transmissions according to the LTE standard.

The carrier can be of almost any design. It is ideal if the surface has no electrically conductive properties, so that short circuits or leakage currents can be ruled out if the conductors of the battery are printed directly on the carrier. For example, the carrier can be a plastic-based label. Suitable would be, for example, a film made of a polyolefin or of polyethylene terephthalate, which has an adhesive surface on one side with which it can be fixed to a product. The electrical conductors of the battery and its other functional parts can be applied to the other side.

In preferred embodiments, the radio tag may be configured to obtain electrical energy from the environment surrounding the radio tag. For this purpose, the radio tag may be equipped with an energy converter capable of converting energy from the environment into electrical energy. For example, the piezoelectric effect, the thermoelectric effect or the photoelectric effect can be used for the conversion. The energy from the environment can be provided, for example, in the form of light, electric fields, magnetic fields, electromagnetic fields, motion, pressure and/or heat and/or other forms of energy, and can be used or “harvested” by means of the energy converter.

In preferred embodiments, the energy converter is coupled to the battery so that it can charge it. It is true that zinc-manganese oxide or zinc-silver oxide cells belong to the so-called primary cells, which are basically not intended for recharging. To a limited extent, however, recharging also works for such cells.

Further features and advantages resulting from aspects of the present disclosure will be apparent from the following embodiments and the drawings, with the aid of which the invention can be explained. The embodiments described below serves merely to explain and provide a better understanding of the invention and are not to be understood as limiting in any way.

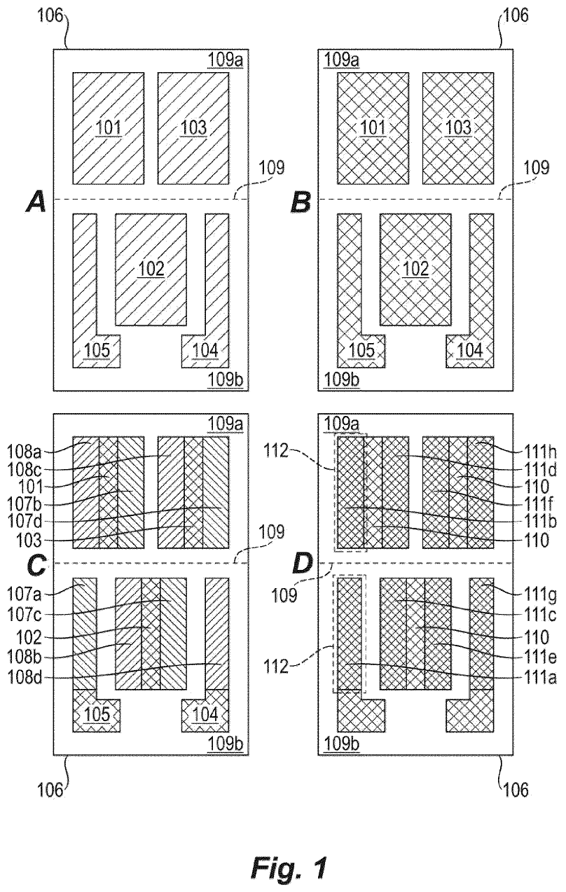

With reference to FIG. 1, both the manufacture and the structure of a preferred embodiment of a battery 100 with four single cells electrically connected in series can be explained. The method of manufacture comprises the following steps:

(1) A current conductor structure is printed by screen printing on a PET film 106 having a thickness of 200 μm, which serves as a substrate. The PET film 106 is divided by the line 109 into two regions 109a and 109b, of which the region 109a serves as the first substrate and the region 109b serves as the second substrate. The current conductor structure includes the first electrical conductor 101, the second electrical conductor 102, the third electrical conductor 103, the fourth electrical conductor 104, and the fifth electrical conductor 105. The first and third conductors 101 and 103 are printed on the first substrate 109a in this case. The conductors 102, 104 and 105 are printed on the second substrate 109b. The printing paste used here is a commercially available silver conductive paste. In the area of the electrical conductors 101-105, the PET film 106 is coated with the paste over the entire surface in each case, so that the conductors each form a continuous electrically conductive surface. All electrical conductors are preferably formed as layers with a thickness in the range from 10 μm μm to 100 μm.

The result of this step is shown in FIG. 1A, where it should be noted that all layers shown in the drawing are arranged parallel to the drawing plane. This applies analogously to carbon, electrode and electrolyte layers deposited on the conductors.

(2) In a further step, the current conductor structure is covered with a thin layer of carbon particles. The layer of carbon particles is preferably formed with a thickness of 12 μm. The printing paste used here is a typical carbon paste of the type used to form electrically conductive layers and connections in electronics. The result of this step is shown in FIG. 1B.

In order to optimize the coverage of the current-conducting structure by the layer of carbon particles, it may be preferable to subject the formed layer to a heat treatment. The temperature that can be applied primarily depends on the thermal stability of the PET film and must be selected accordingly.

(3) Then, the negative electrodes 107a, 107b, 107c and 107d and the positive electrodes 108a, 108b, 108c and 108d are printed on the current conductor structure. For this purpose, the first electrical conductor 101 is overprinted in areas with a zinc paste to form the negative electrode 107b, and is overprinted in areas with a manganese oxide paste to form the positive electrode 108a. The second electrical conductor 102 is overprinted with the zinc paste in some areas while forming the negative electrode 107c, and is overprinted with the manganese oxide paste in some areas while forming the positive electrode 108b. The third electrical conductor 103 is overprinted with the zinc paste in some areas to form the negative electrode 107d and with the manganese oxide paste in some areas to form the positive electrode 108c. The fourth electrical conductor 104 is overprinted with the manganese oxide paste in areas to form the positive electrode 108d. And the fifth electrical conductor 105 is regionally overprinted with the zinc paste to form the negative electrode 107a. The pastes have the following compositions:

Zinc Paste:

| | |
|---|---|
| Zinc particles | 70 wt. % |
| CMC | 2 wt. % |
| SBR | 6 wt. % |
| Solvent (water) | 22 wt. % |

Manganese Oxide Paste:

| | |
|---|---|
| Manganese oxide | 60 wt. % |
| Graphite | 6 wt. % |
| Zinc chloride | 2 wt % |
| CMC | 2 wt. % |
| SBR | 5 wt. % |
| Solvent (water) | 25 wt. % |

The result of this step is shown in FIG. 1C.

The negative electrodes 107a-107d and the positive electrodes 108a-108d are each formed as rectangular strips with a length of 11 cm and a width of 2 cm. The negative electrodes 107a-107d are preferably formed here as layers with a thickness of 70 μm. The positive electrodes 108a-108d are preferably formed as layers with a thickness of 280 μm. More than one printing process may be required to form the positive electrodes 108a-108d.

Two of the electrodes are electrically connected to each other via the first conductor 101, the second conductor 102, and the third conductor 103. The conductor 101 connects the positive electrode 108a to the negative electrode 107b, the conductor 102 connects the positive electrode 108b to the negative electrode 107c, and the conductor 103 connects the positive electrode 108c to the negative electrode 107d. These electrical connections are the basis for the desired serial connection of the four single cells.

The conductors 101, 102, and 103, each electrically connecting two electrodes to each other, each form an electrically conductive area on the surface of the respective substrate 109a and 109b that is larger than the area occupied by the electrically connected electrodes 108a and 107b, 108b and 107c, and 108c and 107d on the surface. In one aspect, the electrically conductive areas each include an area covered by the electrodes. Secondly, a gap 110 is formed between each of the electrically connected electrodes to separate the electrodes from each other. The electrically conductive surfaces also extend across this gap 110, with the result that the cross-section of the conductor does not decrease in the gap between the electrodes.

All this has a positive effect on the impedance values of the battery 100. The large-area contacting of the electrodes and in particular also the connection via the gap 110 ensures optimum electrical connection of the electrodes and minimizes electrical resistances.

Also, the fourth and fifth conductors 104 and 105, which are in electrical contact only with the electrodes 107a and 108d, form an electrically conductive area on the surface of the respective substrate that is larger than the area occupied by the respective electrically contacted electrode on the surface. In one aspect, the electrically conductive areas each comprise an area covered by the electrodes. On the other hand, the electrically conductive surfaces each comprise an area not covered by electrode material. These areas may serve as poles of the battery 100 to tap the added voltage of its four serially connected single cells.

(5) In a further subsequent step, the negative electrodes 107a-107d and the positive electrodes 108a-108d are printed with a zinc chloride paste. The electrolyte layers 111a-111h are formed, each of which has a thickness of approx. 50 μm, for example.

The result of this step is shown in FIG. 1D.

Preferably, an electrolyte paste with the following composition is used in this step:

| | |
|---|---|
| Zinc chloride | 35 wt. % |
| Floating agent (silicon dioxide) | 3 wt. % |
| Mineral, water-insoluble particles | 15% wt. % |
| Solvent (water) | 47 wt. % |

The actuator and the water-insoluble particles have an electrically insulating effect.

It is particularly advantageous if, before the paste is printed around the individual electrodes, a sealing frame 112 is formed, for example by means of an adhesive compound, which encloses the electrodes. A commercially available solder resist, for example, can serve as the starting material for forming the sealing frame 112. Two sealing frames 112 enclosing the electrodes 107a and 108a are shown by way of example. If the process is carried out appropriately, it is expedient to enclose all electrodes with sealing frames.

(6) Then, the electrolyte layers 111a-111h are covered with one or more separators, preferably immediately after printing the electrolyte layers so that the electrolyte layers do not dry out. Then the PET film 106 is folded along the line 109 and folded over so that
the negative electrode 107a forms a first layer stack with the separator or one of the separators and with the positive electrode 108a,
the negative electrode 107b forms a second layer stack with the separator or one of the separators and with the positive electrode 108b,
the negative electrode 107c forms a third layer stack with the separator or one of the separators and with the positive 108c, and
the negative electrode 107d forms a fourth layer stack with the separator or one of the separators and with the positive electrode 108d.

By wrapping and a final welding and/or bonding, a closed housing can be formed in which the layer stacks are arranged.

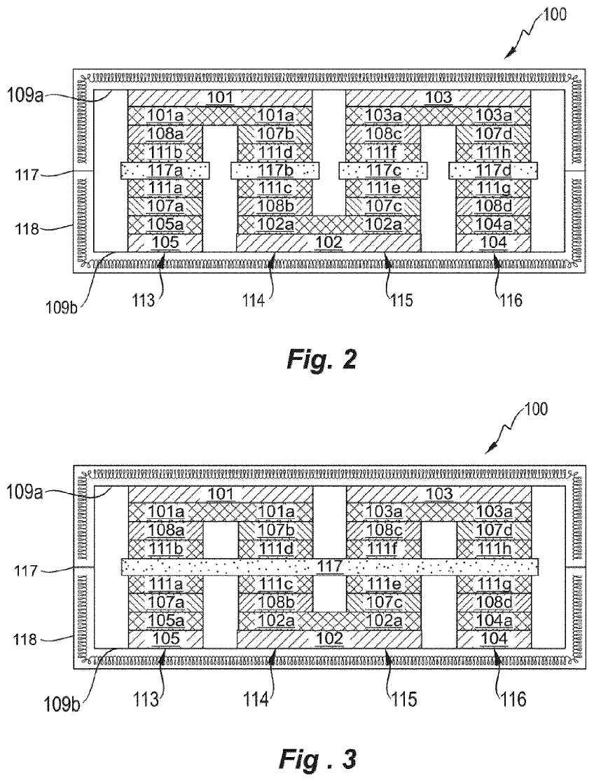

The result of this step is shown in FIGS. 2 and 3.

For example, a commercially available nonwoven separator or a microporous polyolefin film can be used as the separator or separators. Preferably, a microporous polyolefin film with a thickness in the range of 60-120 μm and a porosity (ratio of void volume to total volume) of 35-60% is used.

The battery 100 shown in cross-section in FIG. 2 comprises four single cells 113, 114, 115 and 116 formed as a layer stack. The battery shown can be manufactured according to the procedure illustrated in FIG. 1, whereby a total of four separators 117a-117d formed as a layer are used to form the single cells.

In addition to the separators 117a-117d, the layer stacks 113-116 each include one of the negative electrodes 107a-107d and one of the positive electrodes 108a-108d. In detail:

The layer stack 113 includes electrical conductors 101 and 105, which comprise layers 101a and 105a of carbon particles that protect them from contact with the electrolyte. The positive electrode 108a is deposited directly on the layer 101a, and the negative electrode 107a is deposited directly on the layer 105a. Between electrodes 107a and 108a is separator 117a, which is framed by electrolyte layers 111a and 111b. Since the electrolyte layers 111a and 111b help to electrically isolate the positive electrode 108a and the negative electrode 107a from each other by their content of electrically non-conductive components, they can be regarded as components of the separator 117a.

The layer stack 114 includes electrical conductors 101 and 102, which comprise layers 101a and 102a of carbon particles that protect them from contact with the electrolyte. Positive electrode 108b is deposited directly on layer 102a, and negative electrode 107b is deposited directly on layer 101a. Between electrodes 107b and 108b is separator 117b, which is framed by electrolyte layers 111c and 111d. Since the electrolyte layers 111c and 111d help to electrically isolate the positive electrode 108b and the negative electrode 107b from each other due to their proportion of electrically non-conductive components, they can be regarded as components of the separator 117b.

The layer stack 115 includes electrical conductors 102 and 103, which comprise layers 102a and 103a of carbon particles that protect them from contact with the electrolyte. Positive electrode 108c is deposited directly on layer 103a, and negative electrode 107c is deposited directly on layer 102a. Between electrodes 107c and 108c is separator 117c, which is framed by electrolyte layers 111e and 111f. Since the electrolyte layers 111e and 111f help to electrically isolate the positive electrode 108c and the negative electrode 107c from each other due to their content of electrically non-conductive components, they can be regarded as components of the separator 117c.

The layer stack 116 includes electrical conductors 103 and 104, which comprise layers 103a and 104a of carbon particles that protect them from contact with the electrolyte. Positive electrode 108d is deposited directly on layer 104a, and negative electrode 107d is deposited directly on layer 103a. Between electrodes 107d and 108d is separator 117d, which is framed by electrolyte layers 111g and 111h. Since the electrolyte layers 111g and 111h help to electrically isolate the positive electrode 108d and the negative electrode 107d from each other due to their content of electrically non-conductive components, they can be regarded as components of the separator 117d.

The first conductor 101 and the third conductor 103 are objectionably disposed from each other on a surface of the first substrate 109a facing the second substrate 109b, while the second conductor 102, the fourth conductor 104 and the fifth conductor 105 are objectionably disposed from each other on a surface of the second substrate 109b facing the first substrate 109a,

The four single cells 113, 114, 115 and 116 are electrically connected in series so that their voltages add up. For this purpose, electrodes of opposite polarity of the single cells are electrically connected to each other via the first conductor 101, the second conductor 102 and the third conductor 103. The conductors electrodes have opposite polarity, and the first conductor is electrically in contact with an electrode of the fourth single cell, the electrodes electrically connected by this conductor also having opposite polarity. As noted above, areas of conductors 104 and 105 not covered by electrode material may serve as terminals of battery 100 to tap the added voltage of its four serially connected single cells 113-116.

Since the single cells 113-116 described herein are based on zinc manganese dioxide as an electrochemical system, each of the cells provides a nominal voltage of about 1.5 volts. The battery 100 is therefore capable of providing a nominal voltage of about 6 volts.

As a result of the aforementioned wrapping and final welding and/or bonding along the line 117, the battery 110 has a closed housing 118 in which the layer stacks 113 to 116 are arranged. The areas of the conductors 104 and 105 not covered by electrode material can be led out of the housing so that the voltage of the battery 100 can be tapped from the outside.

For the impedance properties of the battery 100, it is essential that the layered components of the single cells 113-116, which are in direct contact within the layer stacks, have contact with each other over as large an area as possible. This is explained with reference to single cell 113.

First, in order to optimize impedance, it is necessary to provide contact between electrodes 107a and 108a and electrical conductors 101 and 105 over as large an area as possible. As explained above, conductors 101 and 105 form continuous electrically conductive surfaces on substrates 109a and 109b, respectively, as shown in FIGS. 1A and 1B. The electrically conductive surface formed by the conductor 101 and the electrode 108a deposited thereon approximately overlap in the direction of view perpendicular to the electrode 108a and the conductor 101 in an overlay region in which a straight line perpendicular to the electrode 108a intersects both the electrode and the conductor 101. In the specific case, this overlay region is exactly the area of the electrode 108a. Thus, the electrode 108a is in full surface contact with the electrical conductor 101. In the case of the contact between the electrode 107a and the conductor 105, the same applies analogously. Here, too, there is full-surface contact.

Also of importance is the connection of electrodes 107a and 108a to separator 117a. As explained above, the separator 117a is in contact with the electrodes 107a and 108a via the electrolyte layers 111a and 111b, whereby in the present example the electrolyte layers 111a and 111b are regarded as part of the separator 117a. One side of the separator has a first contact surface to the positive electrode 108a, and the other side parallel thereto has a second contact surface to the negative electrode 107a. Preferably, the contact surfaces overlap each other in the direction of view perpendicular to the separator in an overlap region defined by a straight line perpendicular to the separator intersecting both contact surfaces.

Since the electrodes 107a and 108a have identical surface dimensions and are not offset from one another within the stack, the size of this overlay area corresponds exactly to the size of the electrodes 107a and 108a. The electrodes 107a and 108a are thus not only in full-surface contact with the conductors 101 and 105, but also with the separator or the electrolyte layers 111a and 111b of the separator.

The battery 100 shown in FIG. 3 differs from the battery 100 shown in FIG. 2 only in that the single cells 113-116 of the battery have the porous sheet 117 as a common separator instead of several separators.

The porous sheet 117 has four regions separated from one another, via which the oppositely poled electrodes of the four layer stacks are in contact. The first of these areas is defined by contact surfaces to electrodes 107a and 108a, the second by contact surfaces to electrodes 107b and 108b, the third by contact surfaces to electrodes 107c and 108c, and the fourth by contact surfaces to electrodes 107d and 108d. The use of a common separator 117 can significantly simplify the production of the battery 100.

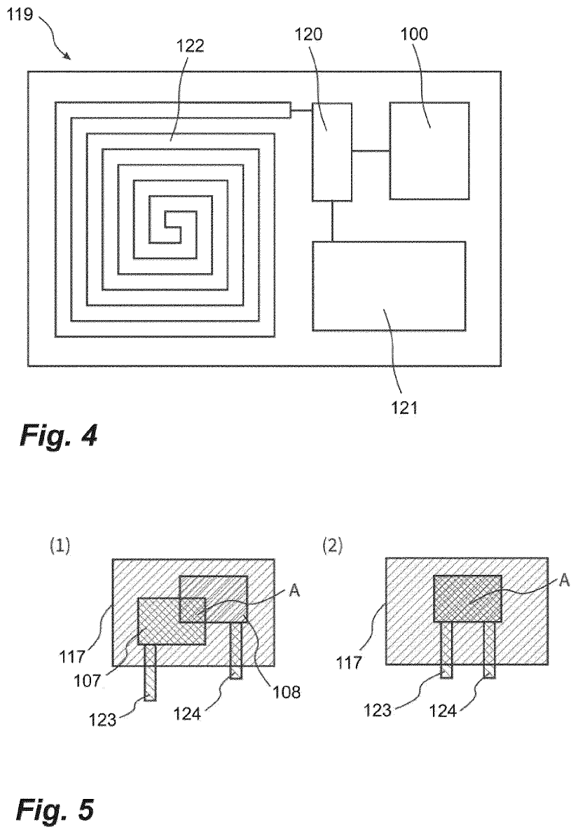

In addition to the battery 100, the radio tag 119 shown in FIG. 4 comprises a transmitter and/or receiver unit 120 for transmitting and/or receiving radio signals, a sensor system 121 and an antenna 122 coupled to the transmitter and/or receiver unit 120. The components of the radio tag are connected via a conductor structure. An adhesive layer (not shown) may be arranged on the underside of the tag 119, by means of which the radio tag 119 can be fixed to a product.

With reference to FIG. 5, the concept of overlay region used in the present application is explained. FIG. 5 shows examples of a layer stack in which a separator 117 formed as a layer is disposed between the negative electrode 107 formed as a layer and the positive electrode 108 formed as a layer. The negative electrode 107 and the positive electrode 108 are each formed as a rectangle, and each covers the same area on the separator 117. All layers are arranged parallel to the drawing plane in the drawing. The area of the separator 117 covered by the negative electrode 107 is defined as the first contact area in the above description. The area of the separator 117 covered by the positive electrode 108 is defined as the second contact area in the above description.

In FIG. 5 (1), the negative electrode 107 and the positive electrode 108 are offset from each other so that the first and second contact areas only partially overlap each other in the viewing direction perpendicular to the drawing plane and thus perpendicular to the separator 117. The overlay area A is therefore smaller than the areas covered by the negative electrode 107 and the positive electrode 108 on the separator 117.

In FIG. 5 (2), however, the negative electrode 107 and the positive electrode 108 overlap completely. The size of the overlay area A therefore corresponds exactly to the area of the negative electrode 107 and the positive electrode 108.

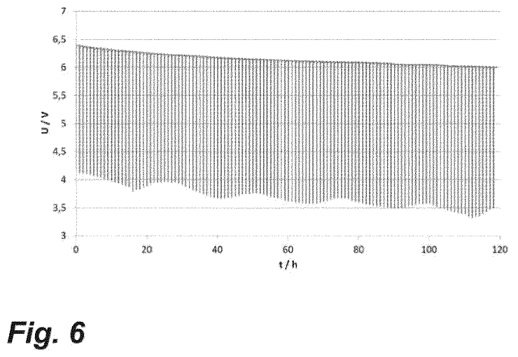

The results of a pulse test shown in FIG. 6 were carried out with a battery comprising four single cells connected electrically in series and designed as shown in FIG. 2. The electrodes of the four cells each extended over an area of approximately 22 cm² on the respective substrates. The single cells were electrically connected in series and supplied a nominal voltage of 6 V. In fact, the open-circuit voltage was about 6.4 volts, and the final discharge voltage was about 3.1 volts. Prior to measurement, the battery was stored at 45° for a period of one month to artificially simulate aging. Nevertheless, the battery delivered a total of 118 TX pulses. A fresh battery delivered more than 400 Tx pulses in a load test and is thus ideally suited to power an LTE chip.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A battery for supplying a transmitter and/or receiver of a radio tag with an electrical current of in peak ≥400 mA, the battery comprising:
a first cell and a second cell, each of the first cell and the second cell comprising a respective negative electrode, a respective positive electrode, and a respective separator disposed between the respective positive electrode and the respective negative electrode;
a plurality of separate electrical conductors, comprising:
a first conductor electrically contacts a first electrode of the first cell,
a second conductor electrically connects a second electrode of the first cell to a first electrode of the second cell to form a series connection between the first cell and the second cell, the second electrode of the first cell and the first electrode of the second cell being of opposite polarity; and
a third conductor electrically contacts a second electrode of the second cell; and
a first substrate and a second substrate between which the first cell, the second cell, and the plurality of separate electrical conductors are arranged,
wherein the first and third conductors are disposed at a distance to each other on a surface of the first substrate facing the second substrate, and the second conductor is disposed on a surface of the second substrate facing the first substrate,
wherein the second electrode of the first cell and the first electrode of the second cell are arranged in a form of layers and side by side on the surface of the second substrate facing the first substrate, each covering a partial area of the second conductor and being separated from each other by a gap,
wherein the first electrode of the first cell and the second electrode of the second cell are arranged in a form of layers on the surface of the first substrate facing the second substrate, the first electrode of the first cell covering at least a partial region of the first conductor and the second electrode of the second cell covering at least a partial region of the third conductor, and
wherein the respective separators of the first cell and the second cell, which are also in a form of layers, are each in surface contact with the second electrode of the first cell and/or the first electrode of the second cell with one of their sides and in surface contact with the first electrode of the first cell and/or the second electrode of the second cell with the other of their sides.

2: The battery according to claim 1, further comprising:
a third cell comprising a negative electrode, a positive electrode, and a separator disposed therebetween,
wherein the first cell, the second cell, and the third are connected in series,
wherein the third conductor electrically contacts a first electrode of the third cell, the first electrode of the third cell and the second electrode of the second cell being of opposite polarity, and
wherein the battery further comprises a fourth electrical conductor that electrically contacts a second electrode of the third cell.

3: The battery according to claim 2, wherein at least one of:
the fourth conductor is spaced apart from the second conductor on the surface of the second substrate facing the first substrate,
the first electrode of the third cell is arranged in a form of a layer on the first substrate, covering a partial region of the third conductor and being separated by a gap from the second electrode of the second cell,
the second electrode of the third cell is arranged in a form of a layer on the surface of the second substrate facing the first substrate and covers at least a partial region of the fourth conductor, and/or
the separator of the third cell, which is also in a form of a layer, has one of its sides in surface contact with the second electrode of the third cell and another of its sides in surface contact with the first electrode of the third cell.

4: The battery according to claim 2, further comprising:
a fourth cell comprising a negative electrode, a positive electrode, and a separator disposed therebetween.
wherein the first cell, the second cell, the third cell, and the fourth cell are connected in series,
wherein the first conductor electrically contacts a second electrode of the fourth cell, the second electrode of the fourth cell and the first electrode of the first cell being of opposite polarity, and
wherein the battery further comprises a fifth conductor electrically contacting a first electrode of the fourth cell.

5: The battery according to claim 4, wherein at least one of:
the fifth conductor is arranged in a form of a layer and spaced apart from the second conductor and the fourth conductor on the surface of the second substrate facing the first substrate,
the first electrode of the third cell is arranged in a form of a layer on the first substrate, covering a partial region of the third conductor and being separated by a gap from the second electrode of the second cell,
the second electrode of the third cell is arranged in a form of a layer on the surface of the second substrate facing the first substrate and covers at least a partial area of the fourth conductor,
the second electrode of the fourth cell is arranged in a form of a layer on the first substrate, covering a partial region of the first conductor and being separated by a gap from the first electrode of the first cell,
the first electrode of the fourth cell is arranged in a form of a layer on the surface of the second substrate facing the first substrate and covers at least a partial region of the fifth conductor,
the separator of the third cell, which is also in a form of a layer, has one of its sides in surface contact with the second electrode of the third cell and the other of its sides in surface contact with the first electrode of the third cell, and/or
the separator of the fourth cell, which is also formed as a layer, is in surface contact with the second electrode of the fourth cell with one of its sides and is in surface contact with the first electrode of the fourth cell with the other of its sides.

6: The battery according to claim 1, wherein at least one of:
the second conductor forms an electrically conductive area on the surface of the second substrate that is larger than an area on the surface of the second substrate that is occupied by the second electrode of the first cell and the first electrode of the second cell,
the electrically conductive area and the second electrode of the first cell and the first electrode of the second cell overlap in a viewing direction perpendicular to the second conductor in an overlay area B,
the electrically conductive area on the second substrate includes at least one area which is not included in the overlay area B and in which there is no overlay with the second electrode of the first cell and the first electrode of the second cell, and/or
the at least one area which is not included in the overlay area B extends across the gap separating the second electrode of the first cell and the first electrode of the second cell.

7: The battery according to claim 1, wherein at least one of:
the first conductor and the third conductor form an electrically conductive area on the surface of the first substrate that is larger than an area occupied by the first electrode of the first cell and the second electrode of the second cell on the surface of the first substrate, and/or
the first conductor the first electrode of the first cell overlap in the direction of view perpendicular to the first conductor in an overlay region C and/or the third conductor and the second electrode of the second cell overlap in the direction of view perpendicular to the third conductor in an overlay region D.

8: The battery according to claim 1, wherein the second electrical conductor is formed, at least in some areas, as a continuous electrically conductive layer on the second substrate.

9: The battery according to claim 1, wherein the second electrical conductor is formed, at least regionally, on the second substrate, from lines and/or tracks aligned parallel and/or in a crossed arrangement.

10: The battery according to claim 1, wherein at least one of:
the respective negative electrode and the respective positive electrode of each of the first cell and the second cell are rectangular or in the form of strips,
the gap between the second electrode of the first cell and the first electrode of the second cell has a substantially constant width,
oppositely poled electrodes of the first cell and of the second cell occupy the same area on the respective substrates,
the second electrode of the first cell and the first electrode of the second cell and/or the first electrode of the first cell and the second electrode of the second cell are each aligned parallel to each other,
commonly poled electrodes of the first cell and the second cell have essentially identical dimensions,
each of the electrodes has:
a length in a range of 1 cm to 25 cm, and
a width in a range of 0.5 cm to 10 cm,
the gap has
a length in a range of 1 cm to 25 cm, and
a width in a range of 0.1 cm to 2 cm
each of the electrical conductors has a thickness in a range of 5 μm to 250 μm, and/or
each of the electrodes has a thickness in a range of 10 μm to 350 μm.

11: The battery according to claim 1, further comprising:
a housing enclosing the first cell and the second cell and comprising a first housing inner side and a second housing inner side, wherein the first substrate and the second substrate are part of the housing, the first housing inner side is a surface of the first substrate, and the second housing inner side is a surface of the second substrate,
wherein the first substrate and the second substrate are films or components of a film.

12: The battery according to claim 1, wherein at least one of:
the electrodes are printed electrodes,
the electrical conductors are printed conductors, and/or
the separators are printed separators.

13: The battery according to claim 1, wherein at least one of:
the respective negative electrode of each of the first cell and the second cell comprises particulate metallic zinc or particulate metallic zinc alloy as an electrode active material, and/or
the respective positive electrode of each of the first cell and the second cell comprises a particulate metal oxide as an electrode active material.

14: A radio tag, comprising:
a transmitter and/or receiver for transmitting and/or receiving radio signals; and
the battery according to claim 1, the battery being configured for supplying the transmitter and/or receiver with an electric current.

15: A method of manufacturing a battery according to claim 1, the method comprising:
applying the first electrical conductor and the third electrical conductor to the first substrate and applying the second electrical conductor to the second substrate, wherein the first substrate and the second substrate are electrically non-conductive substrates;
applying the first electrode of the first cell directly to the first electrical conductor and applying the second electrode of the second cell directly to the third electrical conductor;
applying the second electrode of the first cell and the first electrode of the second cell directly to the second conductor so that the second electrode of the first cell and the first electrode of the second cell are separated from each other by the gap;
applying the respective separator of the first cell to the first electrode or the second electrode of the first cell and applying the respective separator of the second cell to the first electrode or the second electrode of the second cell; and
forming the first cell as a layer stack with the sequence negative electrode/separator/positive electrode, and forming the second cell as a layer stack with the sequence negative electrode/separator/positive electrode.
